(19) United States
(12) Patent Application Publication
(10) Pub. No.: US 2026/0106190 A1
(43) Pub. Date: Apr. 16, 2026

(54) CONTROL SYSTEM FOR DISPLACING POOLED MOLECULAR HYDROGEN IN A FUEL CELL VEHICLE

(71) Applicant: GM GLOBAL TECHNOLOGY OPERATIONS LLC., Detroit, MI (US)

(72) Inventors: Kevin Patrick ALDRIDGE, Farmington Hills, MI (US); Stephen William ERSKINE, Sterling Heights, MI (US); Jacqueline Patricia ZIMNY, Novi, MI (US)

(21) Appl. No.: 18/911,381

(22) Filed: Oct. 10, 2024

(51) Int. Cl. H01M 8/0444; B60L 58/33; H01M 8/04014; H01M 8/0432; H01M 8/04701; H01M 8/04746; H01M 8/10

(52) U.S. Cl. CPC H01M 8/04447; B60L 58/33; H01M 8/04014; H01M 8/04358; H01M 8/04738; H01M 8/04753; H01M 2008/1095; H01M 2250/20

(57) ABSTRACT

A control system for a vehicle including a fuel cell system includes at least one of a cooling fan and an aerodynamic device configured to selectively increase airflow under a hood of the vehicle. A thermal management controller is configured to control the at least one of the cooling fan and the aerodynamic device in response to a sensed temperature of a coolant of a coolant system of the vehicle. A sensor is configured to sense a concentration of molecular hydrogen under the hood of the vehicle. A molecular hydrogen airflow controller is configured to selectively request additional airflow from the thermal management controller using the at least one of the cooling fan and the aerodynamic device in response to the sensed concentration of the molecular hydrogen under the hood of the vehicle being greater than a predetermined concentration.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to fuel cell control systems, and more particularly to a control system for displacing pooled molecular hydrogen in a fuel cell vehicle.

A fuel cell system includes an electrochemical cell that converts chemical energy of molecular hydrogen (H₂) and molecular oxygen (O₂) into electricity through a pair of redox reactions. Some fuel cell systems include a proton exchange membrane (PEM) arranged between a cathode electrode and an anode electrode. The fuel cell system includes a gas storage system for the molecular hydrogen.

### SUMMARY

A control system for a vehicle including a fuel cell system includes at least one of a cooling fan and an aerodynamic device configured to selectively increase airflow under a hood of the vehicle. A thermal management controller is configured to control the at least one of the cooling fan and the aerodynamic device in response to a sensed temperature of a coolant of a coolant system of the vehicle. A sensor is configured to sense a concentration of molecular hydrogen under the hood of the vehicle. A molecular hydrogen airflow controller is configured to selectively request additional airflow from the thermal management controller using the at least one of the cooling fan and the aerodynamic device in response to the sensed concentration of the molecular hydrogen under the hood of the vehicle being greater than a predetermined concentration.

In other features, the predetermined concentration is in a range from 1% to 4%. The molecular hydrogen airflow controller forms part of at least one of a fuel cell controller and the thermal management controller. The sensor is arranged in a downwardly facing concave pocket formed under the hood of the vehicle. The molecular hydrogen airflow controller is configured to wake a predetermined period after the vehicle is turned off and to receive the sensed concentration of the molecular hydrogen under the hood of the vehicle from the sensor. The predetermined period is in a range from 6 hours to 18 hours.

In other features, the molecular hydrogen airflow controller is configured to receive the sensed concentration of the molecular hydrogen under the hood of the vehicle while the vehicle is on and the fuel cell system is active. The molecular hydrogen airflow controller is configured to cause the thermal management controller to at least one of open the aerodynamic device and adjust operation of the cooling fan when the sensed concentration of molecular hydrogen under the hood of the vehicle is greater than the predetermined concentration.

In other features, the molecular hydrogen airflow controller is configured to stop requesting additional airflow from the thermal management controller when the sensed concentration of molecular hydrogen under the hood of the vehicle is less than the predetermined concentration.

In other features, while the vehicle is off, the molecular hydrogen airflow controller is configured to wake up on a periodic basis after a predetermined period to receive the sensed concentration of the molecular hydrogen under the hood of the vehicle.

In other features, the molecular hydrogen airflow controller is configured to cause the thermal management controller to open the aerodynamic device and adjust operation of the cooling fan when the sensed concentration of molecular hydrogen under the hood of the vehicle is greater than the predetermined concentration. The predetermined period is in a range from 6 hours to 18 hours.

A method for sensing molecular hydrogen under a hood of a vehicle including a fuel cell system includes controlling at least one of a cooling fan and an aerodynamic device in response to a sensed temperature of a coolant system of the vehicle; sensing a concentration of molecular hydrogen under the hood of the vehicle; and selectively requesting additional airflow under the hood of the vehicle using the at least one of the cooling fan and the aerodynamic device in response to the sensed concentration of the molecular hydrogen under the hood of the vehicle being greater than a predetermined concentration.

In other features, the predetermined concentration is greater than 1%. The method includes sensing the concentration of molecular hydrogen in a downwardly facing concave pocket under the hood of the vehicle. The method includes sensing the concentration of molecular hydrogen a predetermined period after the vehicle is turned off. The predetermined period is in a range from 6 hours to 18 hours.

In other features, the method includes sensing the concentration of molecular hydrogen under the hood of the vehicle while the vehicle is on and the fuel cell system is active. The method includes opening the aerodynamic device and operating the cooling fan when the sensed concentration of molecular hydrogen under the hood of the vehicle is greater than the predetermined concentration. The method includes stop requesting additional airflow under the hood of the vehicle in response to the sensed concentration of molecular hydrogen under the hood of the vehicle is less than the predetermined concentration.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including one or more fuel cell stacks, a fuel cell controller, a thermal management controller, one or more cooling fans, one or more aerodynamic devices, and one or more hydrogen sensors according to the present disclosure;

FIG. 2 illustrates sensing of the concentration of molecular hydrogen in one or more locations under the hood of the vehicle according to the present disclosure; and

FIG. 3 is a flowchart illustrating an example of a method for sensing molecular hydrogen concentration and selectively requesting additional airflow by controlling the cooling fan(s) and/or the aerodynamic shutter(s) in response to the molecular hydrogen concentration according to the present disclosure.

In the drawings, reference numbers may be reused to identify similar and/or identical elements.

### DETAILED DESCRIPTION

While the present disclosure describes an airflow control system for a vehicle including one or more fuel cell stacks, the airflow control system can be used in stationary applications and/or other applications.

Some fuel cells use molecular hydrogen (molecular hydrogen airflow controller) as an energy source. Molecular hydrogen is known for its ability to leak and/or permeate from gas storage systems, connecting conduit, and/or fuel cell stack(s). Molecular hydrogen is lighter than air and may rise and become trapped under the hood of the vehicle. For example, the molecular hydrogen may become trapped in downwardly facing concave pockets under the hood.

Molecular hydrogen is flammable when the concentration is greater than 4% and an ignition source is present. Some jurisdictions require the concentration of molecular hydrogen (molecular hydrogen airflow controller) to be maintained below a first concentration (such as 4%). When the hydrogen concentration rises above the first concentration, these jurisdictions require remedial action to be taken such as a complete shutdown of the fuel cell system. Completely shutting down the fuel cell system may strand the occupants of the vehicle.

In some examples, a molecular hydrogen airflow controller according to the present disclosure monitors the concentration of molecular hydrogen sensed by the one or more hydrogen sensors in one or more locations under the hood while the vehicle is parked or driving. The molecular hydrogen airflow controller selectively requests additional airflow from a thermal management controller using a cooling fan and/or an aerodynamic device. The molecular hydrogen airflow controller increases airflow under the hood in response to a sensed concentration of molecular hydrogen being greater than a second concentration that is less than the first concentration (requiring complete shutdown).

The molecular hydrogen airflow controller may be part of or work together with the fuel cell controller and/or the thermal controller. Normally, the thermal management controller operates the fan and/or aerodynamic devices in response to thermal load (e.g., a sensed coolant temperature of a coolant system cooling the one or more fuel cell stacks). According to the present disclosure, the molecular hydrogen airflow controller requests additional airflow under the hood from the thermal management controller to reduce the concentration of molecular hydrogen before it reaches the first concentration requiring complete shutdown. The additional airflow pushes the trapped molecular hydrogen out of the one or more locations to the atmosphere.

When the concentration of molecular hydrogen is above the second concentration (and below the first concentration requiring complete shutdown), the molecular hydrogen airflow controller causes the thermal management controller opens one or more aerodynamical devices and/or turns on one or more cooling fans to increase airflow under the hood of the vehicle to dilute the concentration of molecular hydrogen in the one or more locations. In effect, the molecular hydrogen airflow controller selectively causes the thermal management controller to adjust or override thermal management based control in response to the additional airflow request.

Some of the leaks or permeation of molecular hydrogen may be transitory in nature. In other words, the leak or permeation is present for a period and then resolves itself. Rather than requiring a complete shutdown of the fuel cell to occur, the molecular hydrogen airflow controller according to the present disclosure periodically monitors the concentration of the molecular hydrogen and selectively requests additional airflow under the hood to attempt to lower the concentration before a complete shutdown of the fuel cell system is required.

In some situations, the airflow control system turns an unrecoverable fault or remedial action into a recoverable fault or remedial action. The airflow control system may also improve the efficiency of the fuel cell system by reducing the need to run a high-power cooling fan continuously for non-thermal reasons.

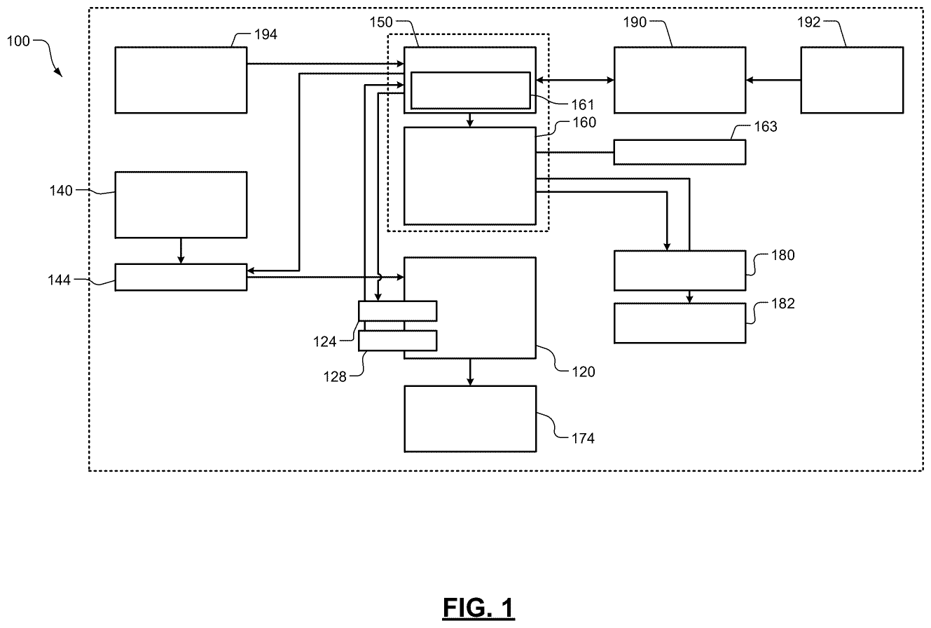

Referring now to FIG. 1, a vehicle 100 includes one or more fuel cell stacks 120. In some examples, the one or more fuel cell stacks 120 include one or more sensors 128 configured to sense operating parameters of the one or more fuel cell stacks 120. In some examples, the one or more fuel cell stacks 120 include one or more actuators 124 to adjust operation of the one or more fuel cell stacks 120. A hydrogen source 140 supplies molecular hydrogen to the one or more fuel cell stacks 120. In some examples, a fuel supply controller 144 controls/meters supply of the molecular hydrogen to the one or more fuel cell stacks 120.

A fuel cell controller 150 controls the one or more fuel cell stacks 120 and communicates with the fuel supply controller 144, the actuators 124, and a thermal management controller 160. The thermal management controller 160 controls airflow based on the thermal load the temperature of the coolant and/or the additional airflow request. In some examples, the fuel cell controller 150 (or optionally the thermal management controller 160) also includes a molecular hydrogen airflow controller 161 that selectively requests the additional airflow under the hood based on sensed molecular hydrogen concentration (and independently of the thermal load). As can be appreciated, the fuel cell controller 150, the thermal management controller 160, and/or the molecular hydrogen airflow controller 161 can be implemented by the same controller or two or more separate controllers can be used.

In some examples, the fuel cell controller 150 monitors the sensors 128 and/or other sensors 163 (e.g., temperature, pressure, flow rate, load, and/or other parameters) to control the one or more fuel cell stacks 120.

The thermal management controller 160 controls operation of one or more cooling fans 180 and/or one or more aerodynamic devices 182 to adjust airflow supplied to one or more vehicle locations (such as under a hood of the vehicle) in response to sensed temperatures, vehicle load, and/or the additional airflow request. For example during normal operation, the thermal management controller 160 uses the one or more aerodynamic devices 182 to selectively allow airflow or to restrict airflow into an under hood volume in response to one or more coolant or other temperatures sensed by the sensors 128 and/or the sensors 163. One or more cooling fans 180 can be used to increase airflow into the under hood volume independently of the one or more aerodynamic devices 182 (which can be closed, partially opened, or fully opened).

The one or more fuel cell stacks 120 output power to one or more loads 174 such as one or more electric motors, a battery module, and/or vehicle accessory loads. A vehicle controller 190 receives user inputs such as vehicle “ON” and vehicle “OFF” signals, torque requests, braking requests, etc. For example, the fuel cell controller 150 adjusts output of the one or more fuel cells stacks 120 based on the torque request.

One or more hydrogen sensors 194 are arranged in one or more locations. For example, the one or more hydrogen sensors 194 can be arranged in pockets under the hood of the vehicle where molecular hydrogen is likely to rise and pool. The one or more hydrogen sensors 194 sense molecular hydrogen concentrations in the one or more locations. In some examples, each of the sensed locations includes one hydrogen sensor or a pair of hydrogen sensors that can be used to provide sensing redundancy.

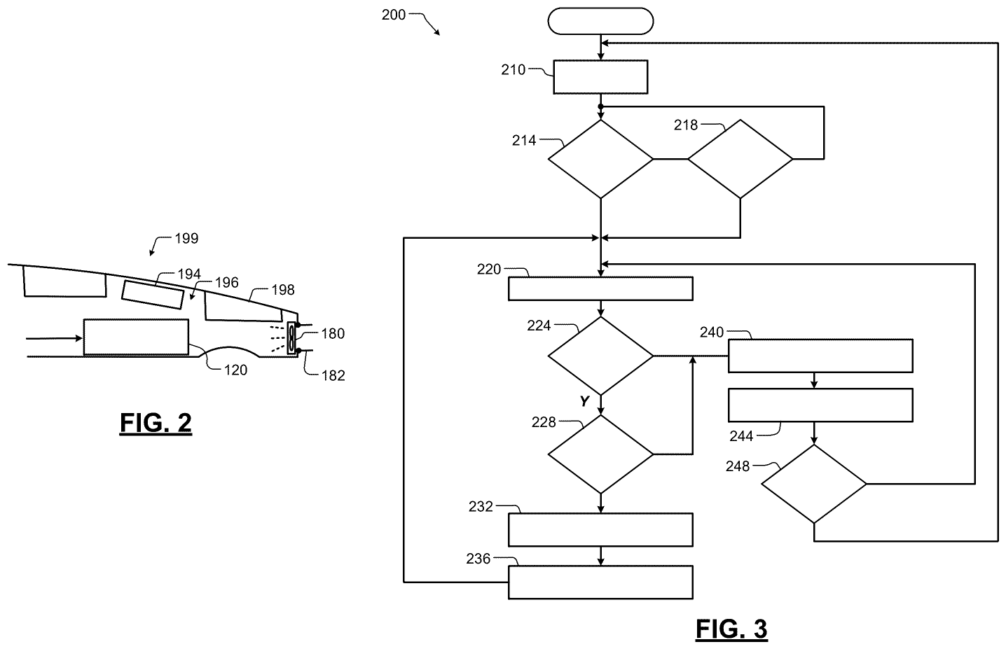

Referring now to FIG. 2, the hydrogen sensor 194 is arranged under a hood 198 of a vehicle 199. Molecular hydrogen may leak or permeate from the one or more fuel cell stacks 120 and flow upwardly into a pocket 196 or other under hood location. The hydrogen sensor 194 senses the concentration of the molecular hydrogen in the pocket 196. The molecular hydrogen airflow controller 161 requests additional airflow from the thermal management controller. In response to the request for additional airflow, the thermal management controller selectively adjusts the aerodynamic devices 182 (e.g., an aerodynamic shutter) and/or the cooling fan 180 to dilute the concentration of the molecular hydrogen.

Referring now to FIG. 3, a method for controlling airflow at one or more vehicle locations (e.g., under a hood) of a fuel cell vehicle is shown. At 210, a timer is reset. At 214, the method determines whether the timer is greater than a predetermined period (t_{TH}). In some examples, the predetermined period is in a range from 6 hours to 18 hours, although shorter or longer periods can be used. In some examples, the predetermined period is in a range from 10 hours to 14 hours (e.g., 12 hours), although shorter or longer periods can be used. If 214 is false, the method determines whether the vehicle is “ON” and the fuel cell system is active.

If not, the method returns to 214. If either 214 or 218 are true, the method continues at 220 and monitors one or more hydrogen sensors sensing molecular hydrogen concentration at one or more vehicle locations. At 224, the method determines whether the concentration of molecular hydrogen is greater than a predetermined threshold C_{TH} corresponding to the second concentration. In some examples, the predetermined threshold is in a range from 1% to 4%. In some examples, the predetermined threshold is in a range from to 1% to 2%.

If 224 is true, the method continues at 228 and determines whether fan enable conditions are met. In some examples, the fan enable conditions include ambient temperature being greater than a predetermined temperature. For example, operating the cooling fan may reduce under the hood temperature which may cause faults in a refrigerant system due to excessive airflow. In some examples, the fan enable conditions may require the hood to be closed.

If 228 is true, the method continues at 232 and adjusts or opens the aerodynamic device(s). At 236, the method operates the cooling fan. The method continues at 220. If either 224 or 228 are false, the method stops overriding thermal driven control of the one or more cooling fan(s) at 240 and stops overriding thermal driven control of the one or more aerodynamic device(s). At 248, the method determines whether the vehicle is “ON” and active. If true, the method returns to 220. If false, the method continues at 210. The increased airflow to the one or more vehicle locations dilutes the molecular hydrogen concentration in these locations.

In some examples, the molecular hydrogen airflow controller sets a first type of fault when the sensed concentration is greater than the second concentration (e.g., 1%) but less than the first concentration (e.g. 4%). In some examples, the molecular hydrogen airflow controller sets a second type of fault when the sensed concentration is greater than the first concentration (e.g., 4%) and performs other remedial actions such as shutting down or preventing operation of the fuel cell stack.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A control system for a vehicle including a fuel cell system, comprising:
at least one of a cooling fan and an aerodynamic device configured to selectively increase airflow under a hood of the vehicle;
a thermal management controller configured to control the at least one of the cooling fan and the aerodynamic device in response to a sensed temperature of a coolant of a coolant system of the vehicle;
a sensor configured to sense a concentration of molecular hydrogen under the hood of the vehicle; and
a molecular hydrogen airflow controller configured to selectively request additional airflow from the thermal management controller using the at least one of the cooling fan and the aerodynamic device in response to the sensed concentration of the molecular hydrogen under the hood of the vehicle being greater than a predetermined concentration.

2. The control system of claim 1, wherein the predetermined concentration is in a range from 1% to 4%.

3. The control system of claim 1, wherein the molecular hydrogen airflow controller forms part of at least one of a fuel cell controller and the thermal management controller.

4. The control system of claim 1, wherein the sensor is arranged in a downwardly facing concave pocket formed under the hood of the vehicle.

5. The control system of claim 1, wherein the molecular hydrogen airflow controller is configured to wake a predetermined period after the vehicle is turned off and to receive the sensed concentration of the molecular hydrogen under the hood of the vehicle from the sensor.

6. The control system of claim 5, wherein the predetermined period is in a range from 6 hours to 18 hours.

7. The control system of claim 1, wherein the molecular hydrogen airflow controller is configured to receive the sensed concentration of the molecular hydrogen under the hood of the vehicle while the vehicle is on and the fuel cell system is active.

8. The control system of claim 1, wherein the molecular hydrogen airflow controller is configured to cause the thermal management controller to at least one of open the aerodynamic device and adjust operation of the cooling fan when the sensed concentration of molecular hydrogen under the hood of the vehicle is greater than the predetermined concentration.

9. The control system of claim 1, wherein the molecular hydrogen airflow controller is configured to stop requesting additional airflow from the thermal management controller when the sensed concentration of molecular hydrogen under the hood of the vehicle is less than the predetermined concentration.

10. The control system of claim 1, wherein while the vehicle is off, the molecular hydrogen airflow controller is configured to wake up on a periodic basis after a predetermined period to receive the sensed concentration of the molecular hydrogen under the hood of the vehicle.

11. The control system of claim 10, wherein the molecular hydrogen airflow controller is configured to cause the thermal management controller to open the aerodynamic device and adjust operation of the cooling fan when the sensed concentration of molecular hydrogen under the hood of the vehicle is greater than the predetermined concentration.

12. The control system of claim 10, wherein the predetermined period is in a range from 6 hours to 18 hours.

13. A method for sensing molecular hydrogen under a hood of a vehicle including a fuel cell system, comprising:
controlling at least one of a cooling fan and an aerodynamic device in response to a sensed temperature of a coolant system of the vehicle;
sensing a concentration of molecular hydrogen under the hood of the vehicle; and
selectively requesting additional airflow under the hood of the vehicle using the at least one of the cooling fan and the aerodynamic device in response to the sensed concentration of the molecular hydrogen under the hood of the vehicle being greater than a predetermined concentration.

14. The method of claim 13, wherein the predetermined concentration is greater than 1%.

15. The method of claim 13, further comprising sensing the concentration of molecular hydrogen in a downwardly facing concave pocket under the hood of the vehicle.

16. The method of claim 13, further comprising sensing the concentration of molecular hydrogen a predetermined period after the vehicle is turned off.

17. The method of claim 16, wherein the predetermined period is in a range from 6 hours to 18 hours.

18. The method of claim 13, further comprising sensing the concentration of molecular hydrogen under the hood of the vehicle while the vehicle is on and the fuel cell system is active.

19. The method of claim 18, further comprising opening the aerodynamic device and operating the cooling fan when the sensed concentration of molecular hydrogen under the hood of the vehicle is greater than the predetermined concentration.

20. The method of claim 18, further comprising stop requesting additional airflow under the hood of the vehicle in response to the sensed concentration of molecular hydrogen under the hood of the vehicle is less than the predetermined concentration.
